(19) United States
(12) Patent Application Publication
(10) Pub. No.: US 2023/0391463 A1
(43) Pub. Date: Dec. 7, 2023

(54) FLEXIBLE ARCHITECTURE FOR AN AEROSPACE HYBRID SYSTEM AND OPTIMIZED COMPONENTS THEREOF

(71) Applicant: VerdeGo Aero, Inc., De Leon Springs, FL (US)

(72) Inventors: Eric Richard Bartsch, Willmette, IL (US); Richard Pat Anderson, De Leon Springs, FL (US); David Eichstedt, Greenwood, IN (US); David N. Spitzer, Port Orange, FL (US); Austin Cassels, Daytona Beach, FL (US); Xavier Gerardo Santacruz, Port Orange, FL (US); Patrick Currier, Port Orange, FL (US)

(21) Appl. No.: 18/236,349

(22) Filed: Aug. 21, 2023

Related U.S. Application Data
(63) Continuation of application No. PCT/US22/17383, filed on Feb. 22, 2022.
(60) Provisional application No. 63/151,760, filed on Feb. 21, 2021.
(60) Provisional application No. 63/163,165, filed on Mar. 19, 2021.
(60) Provisional application No. 63/280,543, filed on Nov. 17, 2021.

(51) Int. Cl. B64D 31/00; B64D 27/24; B64D 27/08

(52) U.S. Cl. CPC B64D 31/00; B64D 27/24; B64D 27/08; B64D 2027/026

(57) ABSTRACT

A hybrid powertrain system includes an engine, an electric machine having a power shaft therein, and a clutch configured to releasably engage an output of the engine and the power shaft of the electric machine. The electric machine further includes an electrical output. The power shaft is configured to mechanically attach to and provide mechanical power to a propulsion device. A controller is configured to control the engine, the electric machine, and the clutch to implement one or more power output modes.

### CROSS-REFERENCE TO RELATED PATENT APPLICATIONS

This application is a continuation of PCT/US2022/017383, filed Feb. 22, 2022, which claims the benefit of U.S. Provisional Patent Application No. 63/280,543, filed Nov. 17, 2021, U.S. Provisional Patent Application No. 63/163,165, filed Mar. 19, 2021, and U.S. Provisional Patent Application No. 63/151,760, filed Feb. 21, 2021, the entire contents of each of which are hereby incorporated by reference in their entirety.

### BACKGROUND

There are varying types of aircraft that are propelled using different types of propulsion mechanisms, such as propellers, turbine or jet engines, rockets, or ramjets. Different types of propulsion mechanisms may be powered in different ways. For example, some propulsion mechanisms like a propeller may be powered by an internal combustion engine or an electric motor. As such, the combination of propulsion mechanisms and methods for providing power to those propulsion mechanisms are often designed specifically for particular aircraft, so that the propulsion mechanisms and methods for providing power to those propulsion mechanisms meet the specifications required to properly and safely propel an aircraft.

### SUMMARY

In an embodiment, A hybrid powertrain system includes an engine, an electric machine having a power shaft therein, and a clutch configured to releasably engage an output of the engine and the power shaft of the electric machine. The electric machine further includes an electrical output. The power shaft is configured to mechanically attach to and provide mechanical power to a propulsion device. A controller is configured to control the engine, the electric machine, and the clutch to implement one or more power output modes.

In an embodiment, a hybrid powertrain system includes an engine, a power shaft, and an electric machine having the power shaft therein. The electric machine further includes an electrical input/output. The hybrid powertrain system further includes a clutch configured to releasably engage an output of the engine to the power shaft. The electric machine is configured to receive power via the electrical input/output from an electric energy storage device to drive the power shaft. The electric machine is configured to output power via the electrical input/output upon rotation of the power shaft by the engine. The power shaft is configured to mechanically attach to and provide mechanical power to a propulsion device.

In an embodiment, a hybrid powertrain system includes an engine and an electric machine having a power shaft therein. The electric machine further includes comprises an electrical input/output. The power shaft is configured to mechanically attach to and provide mechanical power to a propulsion device. An output of the engine is configured to rotate the power shaft. The engine and the electric machine are configured to operate in a first mode in which the electric machine outputs first electrical power through the electrical input/output based on rotation of the power shaft, where the power shaft is rotated by the engine. The engine and the electric machine are configured to operate in a second mode in which both the engine and the electric machine drive the power shaft, where the electric machine drives the power shaft based on second electrical power received via the electrical input/output.

In an embodiment, a method includes controlling an engine and an electric machine having a power shaft therein to operate in a first mode. The first mode includes driving the power shaft by the engine, where an output of the engine is configured to rotate the power shaft. The first mode further includes outputting first electrical power from the electric machine through an electrical input/output of the electric machine based on the rotating of the power shaft by the engine. The method further includes controlling the engine and the electric machine to operate in a second mode comprising driving the power shaft by the engine and the electric machine simultaneously, where the electric machine drives the power shaft based on second electrical power received via the electrical input/output.

### BRIEF DESCRIPTION OF THE DRAWINGS

FIG. 1A illustrates an example flexible architecture for an aerospace hybrid system in accordance with an illustrative embodiment.

FIG. 1B illustrates an additional example flexible architecture for an aerospace hybrid system in accordance with an illustrative embodiment.

FIG. 2A illustrates a block diagram representative of a first aircraft control system for use with a flexible architecture for an aerospace hybrid system in accordance with an illustrative embodiment.

FIG. 2B illustrates a block diagram representative of a second aircraft control system for use with a flexible architecture for an aerospace hybrid system in accordance with an illustrative embodiment.

FIG. 3 illustrates a first example aircraft with which a flexible architecture for an aerospace hybrid system may be used in accordance with an illustrative embodiment.

FIG. 4 illustrates a second example aircraft with which a flexible architecture for an aerospace hybrid system may be used in accordance with an illustrative embodiment.

FIG. 5 illustrates a third example aircraft with which a flexible architecture for an aerospace hybrid system may be used in accordance with an illustrative embodiment.

FIG. 6 is a flow chart illustrating a first example method for using a flexible architecture for an aerospace hybrid system in different flight phases of an aircraft with a main pusher propeller in accordance with an illustrative embodiment.

FIG. 7 is a flow chart illustrating a second example method for using a flexible architecture for an aerospace hybrid system in different flight phases of an aircraft with a main pusher propeller in accordance with an illustrative embodiment.

FIG. 8 illustrates an example flexible architecture for an aerospace hybrid system having a flywheel in accordance with an illustrative embodiment.

FIG. 9 illustrates a perspective view of an example flexible architecture for an aerospace hybrid system in accordance with an illustrative embodiment.

FIG. 10 illustrates a top view of the example flexible architecture of FIG. 9 in accordance with an illustrative embodiment.

FIG. 11 illustrates a side view of the example flexible architecture of FIG. 9 in accordance with an illustrative embodiment.

FIG. 12 illustrates a perspective view of another example flexible architecture for an aerospace hybrid system in accordance with an illustrative embodiment.

FIG. 13 illustrates example downstream and upstream components for propelling an aircraft in accordance with an illustrative embodiment.

FIG. 14 illustrates an example flexible architecture for an aerospace hybrid system having a flywheel and a spring coupling in accordance with an illustrative embodiment.

FIG. 15 is a diagrammatic view of an example of a computing environment, in accordance with an illustrative embodiment.

### DETAILED DESCRIPTION

Aircraft typically have custom designed propulsion mechanisms and methods for powering those propulsion mechanisms. In this way, the propulsion mechanisms and power supplied to those propulsion mechanisms can be optimized to provide the amount of propulsion needed for a particular type and size of aircraft, while minimizing weight of the components in the aircraft. In other words, the propulsion mechanisms and power for those propulsion mechanisms are often optimized for a particular type and size of aircrafts such that components of one aircraft could not be easily used in a different types of aircraft drive architectures, such as direct drive aircraft, parallel drive aircraft, and serial drive aircraft.

Described herein are various embodiments for a flexible architecture for an aerospace hybrid system and optimized components thereof. A hybrid system may be or may include a system where fuel is burned in a piston, rotary, turbine, or other engine, and an output of the piston engine may be operatively connected to an electric generator for outputting electric power. The embodiments described herein may include flexible systems that can provide power for many different types of aircraft and propulsion mechanisms. Such systems may advantageously reduce the complexity of designing different types of aircraft, may reduce the costs of manufacturing such systems as less customization allows for economies of scale in mass producing the systems, and ultimately may reduce the complexity of aircraft that use the systems described herein.

The flexible architectures described herein may further be used to provide power to propulsion mechanisms in different ways, either in a same aircraft or in different aircraft. For example, a flexible architecture for providing power to propulsion mechanisms may be able to operate in multiple different modes to provide power to different types of propulsion mechanisms. A first aircraft may utilize one, some, or all of the multiple different modes in which the flexible architecture may operate. A second aircraft may utilize one, some, or all of the multiple different modes, and the modes utilized by the second aircraft may be different than those utilized by the first aircraft.

Therefore, different aircraft may take advantage of different modes of providing power to propulsion mechanisms provided by the flexible architectures described herein. While use of the flexible architectures may be customized in this way, the physical hardware of the flexible architectures may be adapted to use by different aircraft with minimal or no changes to the physical components of the flexible architectures described herein. Instead, the use of different modes in different aircraft may be accomplished largely based on how the components of the flexible architectures are controlled using a processor or controller. As such, computer readable instructions may therefore also be stored on a memory operably coupled to a processor or controller, such that when the instructions are executed by the processor or controller, a computing device that includes the processor or controller may control the various components of the flexible architectures described herein to utilize any possible mode of use desired for a particular implementation, aircraft, flight phase, etc.

Power generation and propulsion systems for aircraft may also utilize various cooling systems to ensure that the various components of an aircraft remain at safe temperatures for operation, as well as maintaining components within temperature ranges where they may operate more efficiently. Further described herein are advantageous cooling systems that leverage various aspects of the hybrid architecture described herein to efficiently cool components of a flexible architecture for providing power to propulsion mechanisms of an aircraft.

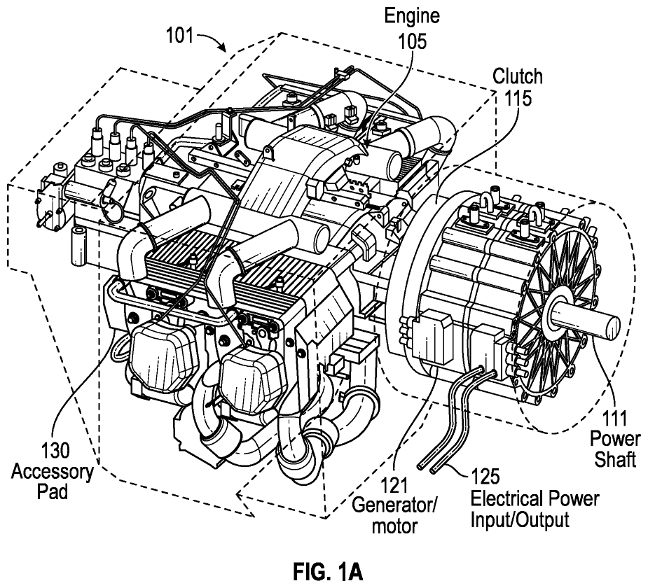

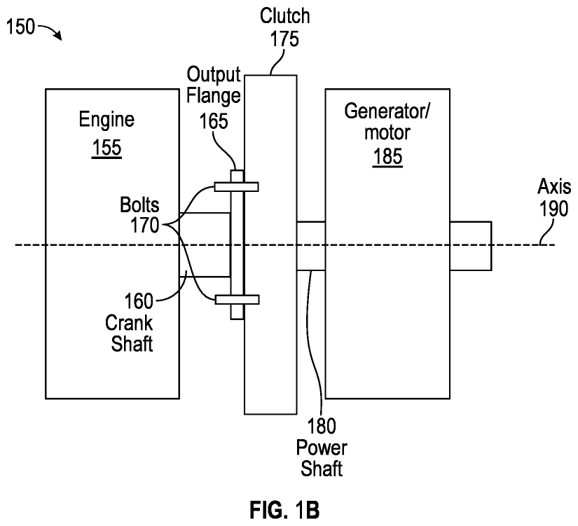

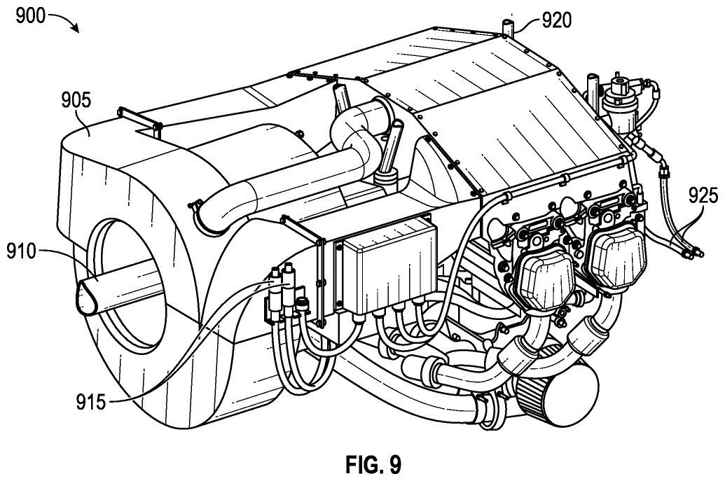

Aircraft that have hardware for providing different modes of power to its propulsion mechanisms, may have a variety of components for which it may be desirable to provide cooling. Thus, a single cooling system that efficiently moves air to the different components that enable different modes of power may cut down on weight of the aircraft, as well as power consumption of the cooling systems. FIGS. 1-8 and their accompanying description below specifically relate to example flexible architectures for providing power to propulsion systems of an aircraft, and FIGS. 9-12 and their accompanying description below relate to various embodiments of cooling systems for the example flexible architectures.

FIG. 1A illustrates an example flexible architecture 101 for an aerospace hybrid system in accordance with an illustrative embodiment. As discussed herein, the flexible architecture 101 may be efficiently used in a wide array of applications with a single hybrid generator system that can be applied in multiple ways depending on the aircraft requirements and phase of flight (e.g., used in different modes).

The flexible architecture 101 of FIG. 1A is a hybrid generator that includes an engine 105, a clutch 115, a generator/motor 121, and a power shaft 111. As described further below, the flexible architecture 101 may be used to implement various different modes depending on requirements of a specific aircraft installation or a specific phase of flight as desired. The engine 105 may be a combustion engine, such as an internal combustion engine. The engine 105 may further specifically be one of a piston internal combustion engine, a rotary engine, or a turbine engine. Such engines may use standard gasoline, jet fuel (e.g., Jet A, Jet A-1, Jet B fuels), diesel fuel, biofuel substitutes, etc. In various embodiments, other types of engines may also be used, such as a smaller engine for drone implementations (e.g., a Rotax gasoline engine).

As described above, the engine 105 may be a piston combustion engine. A piston combustion engine may advantageously spin an output rotor or shaft at rotations per minute (RPMs) that may be more desirable for direct output to power a generator and/or a propulsion mechanisms (e.g., a propeller) than other engines. For example, a piston combustion engine may have an output on the order of thousands of RPMs. For example, a piston combustion engine may have an output anywhere from 2200 to 2500 RPM, which may be a desirable RPM for a propeller. In particular, a propeller may be designed to have a size that yields a desired tip speed of the propeller based on the RPM output of the piston combustion engine (e.g., of 2200 to 2500 RPM). Other types of engines, such as a turbine engine, may output rotational power on the order of tens of thousands of RPMs, much higher than a piston combustion engine. Another embodiment may drive the motor/generator at the higher RPM of a turbine engine to benefit the efficiency, power output, or other important factors. In some embodiments, a gear box could be added between the output of a high RPM engine and the other components of FIG. 1A to step down the output RPM of the engine 105. However, the addition of a gear box may also add weight to the system that is undesirable in some embodiments. A piston combustion engine may further be advantageous with respect to noise as compared to turbine engines. Turbine engines typically are louder than piston combustion engines, and the noise perceived by humans from a turbine engine is typically more offensive to a listener than the noise produced by a piston combustion engine. Quieter engines may also be more valuable in urban or more dense settings where reduced noise is desirable.

The engine 105 may output rotational power to the clutch 115, which may be controlled to engage or disengage the power shaft 111. In other words, the power shaft 111 may be engaged with the rotational output of the engine 105 by the clutch 115, so that rotational force may be transferred between the engine 105 output and the power shaft 111. When the clutch 115 disengages the output of the engine 105 and the power shaft 111, the power shaft 111 may rotate independently of the output of the engine 105. The clutch 115 may be physically located between the engine 105 and the generator/motor 121, and may even contact the engine 105 and the generator/motor 121 on opposing sides in order to reduce the overall footprint of the flexible architecture. In FIG. 1A and further described herein and shown in other figures is the clutch 115. However, in various embodiments, any mechanism that is capable of releasably decoupling the engine 105 and the power shaft 111 may be used additionally or alternatively to a clutch. For example, this decoupling may be based on absolute rotations per minute (RPM) or relative RPM between the engine 105 output and the power shaft 111, such as in an overrunning clutch.

The generator/motor 121 may also be engaged or disengaged with the power shaft 111. In other words, the generator/motor 121 may be controlled to switch off such that rotation of the power shaft 111 does not cause the generator/motor 121 to generate electrical power. Similarly, the generator/motor 121 may also be controlled to switch on such that the rotation of the power shaft causes the generator/motor 121 to generate electrical power. The generator/motor 121 is referred to as a generator/motor because it may function as either a generator or a motor. In various embodiments, the generator/motor 121 may be referred to as an electric machine, where an electric machine may be an electric generator, an electric motor, or both.

The flexible architecture further includes an electrical power input and output (I/O) 125 connected to the generator/motor 121. As described further herein, the generator/motor 121 may generate electrical power based on rotation of the power shaft 111 that is output via the electrical power I/O 125 or may receive electrical power via the electrical power I/O 125 that may be used to drive the power shaft 111. Wiring for the electrical power I/O 125 may include more than one wire. In various embodiments, the wiring for inputting electric power into the generator/motor 121 may be the same wiring that is used for outputting electric power out of the generator/motor 121. In various other embodiments, first wiring may be used for input of electric power and different second wiring may be used for output of electric power (so that different wires are used for input and output). In various embodiments, the generator/motor 121 may also have wiring connected thereto that is used for control of the generator/motor 121, to relay sensor or other data about the operation of the generator/motor 121 to a controller, etc.

The generator/motor 121 may also act as a driver for the power shaft 111. Upon receiving electrical power via the electrical power I/O 125 from batteries or some other form of electrical energy storage elsewhere in the system, the generator/motor 121 may impart a rotational force on the power shaft 111 to drive the power shaft 111. This may occur as long as the generator/motor 121 is controlled to be switched on to engage with the power shaft 111. If the generator/motor 121 is controlled to be switched off such that it does not engage with the power shaft 111, the power shaft 111 may not be rotated by the generator/motor 121.

Electrical power output from the electrical power I/O 125 may be used to drive an electric motor for an electric propulsion mechanism (e.g., a propeller). Electrical power output from the electrical power I/O 125 may also be used to power and/or charge other devices on an aircraft or aerospace vehicle. For example, electrical power output from the electrical power I/O 125 may be used to charge one or more batteries. The electrical power output from the electrical power I/O 125 may also be used to power other devices or accessories on an aircraft or aerospace vehicle. Because the electrical power I/O 125 also has an input, the power shaft 111 may be driven by any electrical power received via the electrical power I/O 125, such as power from one or more batteries. The power generated by the generator/motor 121 may be an alternating current (AC) power. That AC power may be converted by power electronics (e.g., a rectifier or inverter) into direct current (DC) power and output to a DC bus. That DC bus may be connected to batteries and/or an electric propulsion mechanism. In this way, the electric propulsion mechanism may be supplied with power via a DC bus. In various embodiments, a motor of the electric propulsion mechanism may use AC power, and the DC power from the DC bus may therefore be converted from DC power to AC power before it is used by the electric propulsion mechanism (e.g., by an inverter).

Any rotation of the power shaft 111 itself, whether driven by the engine 105 or the generator/motor 121, may also be used to drive one or more propulsion mechanisms. For example, rotation of the power shaft 111 may be used to direct drive a propeller or may be used to power an electric motor that drives a propulsion mechanism. The rotation of the power shaft 111 may also drive a gearbox operably connected to another component, such as one or more propellers, one or more rotors, or other rotating devices for various uses on an aircraft.

An accessory pad 130 may also be coupled to the engine 105, and may include a lower voltage direct current (DC) generator for electrical power that is separate from the generator/motor 121 and the electrical power I/O 125, which may be configured for high voltage and high power I/O. In some embodiments, the generator/motor 121 may also have two different windings and the electrical power I/O 125 may have two different outputs (e.g., high voltage and low voltage). Accessory power may be associated with one of the electrical power I/O 125 outputs in addition to or instead of the accessory pad 130 output. The accessory pad 130 may be used to provide power to devices or accessories on an aircraft or aerospace vehicle that does not require high voltage or current outputs that may be output by the generator/motor 121 at the electrical power I/O 125. A high voltage (HV) of an aircraft may be, for example, 400 volts (V) or 800 V, but may also be anywhere between 50 V to 1200 V. A low voltage (LV) of an aircraft may be 12 V, 14 V, 28 V, or any other voltage below 50 V.

FIG. 1B illustrates an additional example flexible architecture 150 for an aerospace hybrid system in accordance with an illustrative embodiment. In particular, the flexible architecture 150 of FIG. 1B includes some components that may be the same as or similar to the components described above with respect to FIG. 1A, including an engine 155, a clutch 175, a power shaft 180, and/or a generator/motor 185. The flexible architecture 150 further illustrates the output of the engine 155 in the form of a crankshaft 160, which is rigidly connected to an output flange 165. The output flange 165 is rigidly connected to one side of the clutch 175 with bolts 170.

The clutch 175 may be configured to engage the power shaft 180 to translate rotational motion from the crankshaft 160 and the output flange 165 to the power shaft 180. The clutch 175 may be further configured to disengage the power shaft 180 such that the power shaft 180 may rotate independently with respect the crankshaft 160 and the output flange 165. In addition, FIG. 1B demonstrates how the rotatable components of the flexible architecture 150 may be all be aligned along a single axis 190. The rotatable components of FIG. 1A may similarly be aligned along a single axis as shown in FIG. 1B. In addition, the power shaft 180 may be a splined shaft that fits into an inner diameter opening of the clutch 175 and the generator/motor 185. Other features than a spline may also be used, such as a taper. In any case, the generator/motor 185 and/or the clutch 175 may be configured to accommodate and connect to a spline, taper, or other feature on the power shaft 180 so that the components may properly engage with one another.

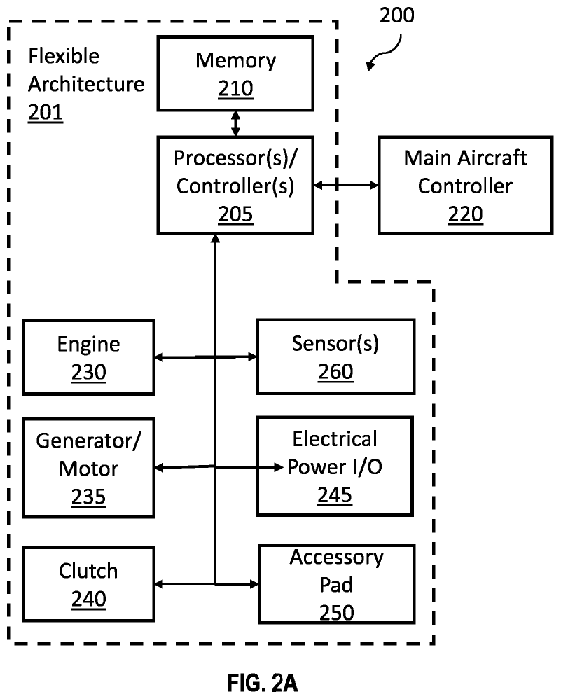

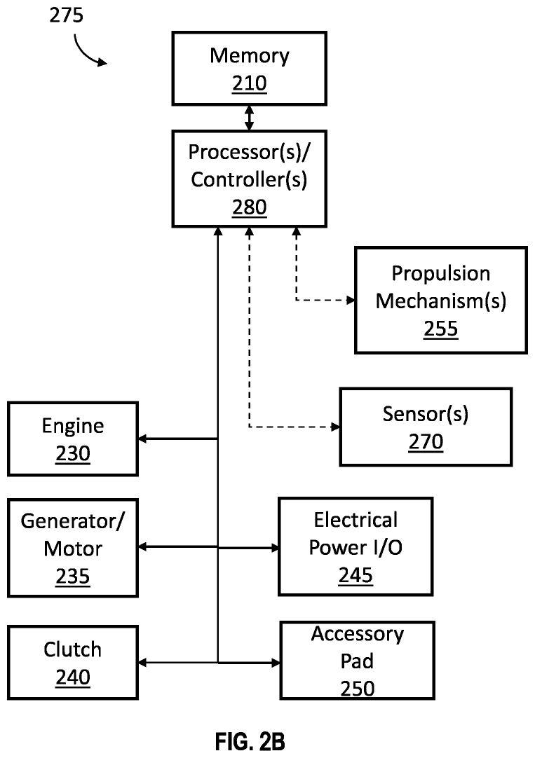

In various embodiments, the clutch 175 may be different types of clutches or other mechanisms capable of decoupling the power shaft 180 from the output of the engine 155. For example, the clutch 175 may be a plate style clutch, and may be a dry or wet clutch. Such a plate style clutch may be engaged/disengaged or otherwise controlled mechanically, hydraulically, and/or electrically (e.g., by controllers 205, 220, and/or 280 of FIGS. 2A and 2B). Plate style clutches may also have different numbers of plates, such as 3, 5, or 10 plates. In various embodiments, the clutch 175 or any other clutch described herein may be a one-way clutch, overrunning, or sprag clutch. The one-way or sprag clutch may be configured to disengage the output of the engine from the power shaft while the electric machine is rotating the power shaft faster than the output of the engine. In other words, if the engine 155 is outputting less power than the generator/motor 185 onto the power shaft 180, the clutch 175 may automatically mechanically disengage the output of the engine 155 from the power shaft 180, for example without any electrical control input used to accomplish said disengagement. Upon the engine 155 having a higher RPM or outputting more power than the generator/motor 185, the one-way or sprag clutch may then engage so that power is applied from the output of the engine 155 to the power shaft 180. Another type of clutch that may be used is a centrifugal clutch, where weights in the plates of a clutch trigger one or more levers progressively as the RPM increases to squeeze the plates of the centrifugal clutch and engage the plates to connect, for example, the output of the engine 155 and the power shaft 180.

Advantageously, the generator/motor 121 of FIG. 1A and/or the generator/motor 185 may be used as a starter for the engine 105 or the engine 155, respectively. In other words, the generator/motor 185 may be used to turn the crankshaft 160 while the clutch 175 is engaged in order to start up the engine 155. Such a system may be advantageous where, for example the generator/motor 185 may be powered by a battery or other electrical power source. The engine 155, which may be a piston combustion engine as described herein, therefore may not require separate starter components, reducing the weight and complexity of the flexible architectures described herein.

FIG. 2A illustrates a block diagram representative of an aircraft control system 200 for use with a flexible architecture 201 for an aerospace hybrid system in accordance with an illustrative embodiment. The aircraft control system 200 may be used, for example, to implement one or more of the various modes discussed below in which the flexible architectures described herein may be used. The flexible architecture 201 may be the same as, similar as, or may have some or all of the components of the flexible architectures 101 and/or 150 of FIGS. 1A and/or 1B. The aircraft control system 200 may include one or more processors or controllers 205 (hereinafter referred to as the controller 205), memory 210, a main aircraft controller 220, an engine 230, a generator/motor 235, a clutch 240, an electrical power I/O 245, an accessory pad 250, and one or more sensor(s) 260. The connections in FIG. 2A indicate control signal related connections between components of the aircraft control system 200. Other connections not shown in FIG. 2A may exist between different aspects of the aircraft and/or aircraft control system 200 for providing electrical power, such as a high voltage (HV) or low voltage (LV) power for an aircraft.

The memory 210 may be a computer readable media configured for instructions to be stored thereon. Such instructions may be computer executable code that is executed by the controller 205 to implement the various methods and systems described herein, including the various modes of using the flexible architectures herein and combinations of those modes. The computer code may be written such that the various methods of implementing different modes of the flexible architectures herein are automatically implemented based on various inputs that indicate, for example, a particular flight phase (e.g., landing, takeoff, cruising, etc.). In various embodiments the computer code may be written to implement the various modes herein based on input from a user or pilot of the aircraft or aerospace vehicle, or may be implemented based on a combination of user input and automatic implementation based on non-human inputs (e.g., from sensors on or off the aircraft, based on planned flight plans, etc.) The controller 205 may be powered by a power source on the aircraft or aerospace vehicle, such as the accessory pad 130, one or more batteries, an output of the electrical power I/O 125, a power bus of the aircraft powered by any power source, and/or any other power source available.

The controller 205 may also be in communication with each of the engine 230, the generator/motor 235, the clutch 240, the electrical power I/O 245, the accessory pad 250, and/or the sensor(s) 260. In this way, the components of flexible architectures may be controlled to implement various modes as described herein. In various embodiments, engine 230, the generator/motor 235, the clutch 240, the electrical power I/O 245, and the accessory pad 250 may be similar to or may be the similarly named components shown in and described above with respect to FIG. 1A. The electrical power I/O 245 may also include pre-charge electronic components, for example, for protecting the electrical components of the flexible architectures, including a direct current (DC) bus, as described herein from excessive in rush current on startup. For example, if a high-voltage (HV) bus is at 400V and a new component is connected to the HV bus at 0 V, the instantaneous current rush may be extremely high and may be damaging to the HV bus and/or the component. As a result, the pre-charge electronic components may provide for slowly bringing up a component voltage before making a full connection to the HV bus or other power supply. In various embodiments, the HV bus may be a DC bus or an AC bus, or there may be multiple busses that are any of DC or AC busses. In instances where an AC bus is used, AC power may be output from a motor/generator to the AC bus directly. In instances where a DC bus is used, an inverter may be used to convert AC power from the motor/generator to DC power for output to the DC bus.

The sensor(s) 260 may include various sensors for monitoring the different components of the flexible architecture 201. Such sensors may include temperature sensors, tachometers, fluid pressure sensors, voltage sensors, current sensors, state sensors to determine, for example, a current state of the clutch 250, or any other type of sensor. For example, voltage and/or current sensors may be used to inform function and settings of a motor/generator, a state chosen for the clutch, or for adjusting any other component of a system. A state sensor could also indicate a specific mode the flexible architecture is being used in, and the system may receive inputs (e.g., from a pilot, from an automated flight controller), to change the system to a different state or mode for a certain phase of flight that may be upcoming. Other sensors may include a pitot tube for measuring aircraft airspeed, an altimeter for measuring aircraft altitude, and/or a global positioning system (GPS) or similar geographic location sensor for determining a location relative to the ground and/or known/mapped structures.

The components of FIG. 2A inside the flexible architecture 201 dashed line may be associated with the flexible architecture as described herein, while the main aircraft controller 220 may be associated with the broader aircraft systems. In other words, the main aircraft controller 220 may control aspects of the aircraft other than the flexible architecture 201, while the controller 205 controls aspects of the aircraft related to the flexible architecture 201. The main aircraft controller 220 and the controller 205 may communicate with one another to coordinate providing power to the various propulsion mechanisms of the aircraft. For example, the main aircraft controller 220 may transmit signals to the controller 205 requesting particular power output levels for one or more particular propulsion mechanisms. The controller 205 may receive such control signals and determine how to adjust the flexible architecture 201 (e.g., what modes to enter and how to control the elements of the flexible architecture 201) to output the desired power levels based on the control signals from the main aircraft controller 220. In various embodiments, the main aircraft controller 220 may transmit signals that are related to controlling specific aspects of the flexible architecture 201. In other words, the controller 205 may act as a relay to retransmit control signals from the main aircraft controller 220 to the components of the flexible architecture 201, in addition to or instead of transmitting desired power output signals to the controller 205 from which the controller 205 determines how to control the individual components of the flexible architecture 201.

In various embodiments, the main aircraft controller 220 may also transmit control signals related to future desired power outputs, future flight phase or flight plan information, etc. In this way, the controller 205 may receive and use information about the expected power demands of the aircraft to determine how to control the aspects of the flexible architecture 201 at both a present moment and in the future. For example, flight plan information may be used to determine when battery power should be used, when batteries should be charged, etc. In another example, if a big demand for power is expected, the controller 205 may ensure that the engine 230 is running at a desired RPM to begin delivering a desired level of power.

In various embodiments, the controller 205 may also be in communication with one or more batteries to monitor their charge levels, control when the batteries are charged or discharged, control when the batteries are used to power the generator/motor 235, control when the batteries are used to directly power another aspect of the aircraft. However, in other embodiments, the main aircraft controller 220 may be in communication with batteries of the aircraft, and/or may relay information related to the batteries and control thereof to the controller 205. Similarly, if the batteries of the aircraft are controlled with the main aircraft controller 220 rather than the controller 205, the controller 205 may transmit control signals related to the batteries to the main aircraft controller so that the batteries may be controlled as needed or desired with respect to the functioning of the flexible architecture 201.

In various embodiments, the electrical power I/O 245 may include two different outputs (e.g., a high voltage (HV) output and low voltage (LV) output) that are associated with two different windings of the generator/motor 235. As such, two different voltages (e.g., HV and LV) may be output and controlled by the controller 205 and/or the main aircraft controller 220. The electrical power I/O 245 may additionally or alternatively have voltage conversion components (e.g., a DC to DC converter) such that two or more different voltages may be output. In such an embodiment, two different outputs may be achieved without the use of two separate windings. The two different outputs may, for example, be output to different power busses on the aircraft, such as a HV bus and a LV bus. The two outputs of the electrical power I/O 245 may also be separately controlled by the controller 205. As such, the outputs may be turned off (e.g., by letting the power shaft and rotor of the generator spin or freewheel with respect to the rest of the motor/generator by turning off field current of the motor/generator). In various embodiments, the power shaft may not actually be freewheeling within the generator/motor 235. Instead, the power shaft may still rotate the rotor of the motor/generator 235 while the stator remains static, but the controller 205 may be used to control the output such that little or no electrical power is actually output by the motor/generator 235. In various embodiments, the controller 205 may control the motor/generator 235 to output a desired level or threshold level of electrical power from the motor/generator 235 while letting the remaining power be output by the power shaft (e.g., to a propulsion mechanism). For example, the controller 205 may control the motor/generator 235 to generate anywhere from 0% to 100% of the power output from the engine to the power shaft into electric power. For example, the controller 205 may cause the motor/generator 235 to generate 0%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 98%, 99%, or 100% of the power from the power shaft into electrical power.

In some embodiments, the accessory pad may not be controlled by the controller 205 and/or the main aircraft controller 220. The accessory pad may simply always be on when the engine 230 is operating, or may be controlled separately (e.g., by a manual switch flipped by a user) to control when and how power is supplied to accessories on the aircraft.

In some embodiments, the controller 205 may be in communication with a wireless transceiver that may be on-board an aircraft or aerospace vehicle, so that the controller 205 may communicate with other computing devices not hard-wire connected to the system 200. In this way, instructions or inputs for implementing the various modes for the flexible architectures described herein may also be received from a remote device computing device wirelessly. In other embodiments, the system 200 may only communicate with components on-board the aircraft.

FIG. 2B illustrates a block diagram representative of a second aircraft control system 275 for use with a flexible architecture for an aerospace hybrid system in accordance with an illustrative embodiment. In the example of FIG. 2B, the system 275 does not have a separate main aircraft controller as in FIG. 2A. Instead, the entire aircraft has a single main controller 280 that controls all aspects of the flexible architecture and the aircraft (including, e.g., propulsion mechanisms 255 of the aircraft).

The controller 285 may be in communication with one or more of the propulsion mechanism(s) 255 on the aircraft to control them. The controller 285 may also be in communication with one or more sensor(s) 270 on an aircraft or aerospace vehicle, which may be sensors of the aircraft and sensors of the flexible architecture. In particular, the sensor(s) 260 may also be embedded in any of the components of FIGS. 1A and/or 1B described above, and therefore may be used to inform how the devices of FIGS. 1A and/or 1B are controlled and/or how the modes described herein are implemented as described herein.

In either of FIG. 2A or 2B, the controller 205, the controller 285, and/or the main aircraft controller 220 may also be in communication with a cooling system configured to cool and/or heat any components of the flexible architecture, one or more batteries, or any other aspect of an aircraft. As such, a cooling system may also be controlled in concert with the other systems and methods described herein.

Described below are five specific modes that may be implemented using various embodiments of the flexible architecture described herein (including, e.g., the flexible architectures shown in and described with respect to FIGS. 1A, 1B, 2A, and 2B).

In a first mode, which may be referred to herein as a hybrid generator mode, a clutch (e.g., the clutch 115 of FIG. 1A and/or the clutch 175 of FIG. 1B) may be controlled to engage an engine (e.g., the engine 105 of FIG. 1A and/or the engine 155 of FIG. 1B) to a power shaft (e.g., the power shaft 111 of FIG. 1A and/or the clutch output/power shaft 180) that runs between the clutch to a generator/motor (e.g., the generator/motor 121 of FIG. 1A and/or the generator motor 185 of FIG. 1B) such that the engine spins the power shaft within the generator/motor to generate electrical power to be supplied via an electrical power I/O (e.g., the electrical power I/O 125 of FIG. 1A) to other systems on an aircraft such as propulsion mechanisms/systems. For example, such propulsion mechanisms/systems may be powered using electric motors, and the electrical power output by the generator/motor in the first mode may be used to drive such propulsion mechanisms/systems. In short, in the first mode, the engine may be engaged with the power shaft using the clutch to drive the generator/motor and output electrical power from the generator/motor.

In a second mode, which may be referred to herein as a direct drive engine mode, a clutch (e.g., the clutch 115 of FIG. 1 and/or the clutch 175 of FIG. 1B) may engage an engine (e.g., the engine 105 of FIG. 1A and/or the engine 155 of FIG. 1B) output to a power shaft (e.g., the power shaft 111 of FIG. 1A and/or the clutch output/power shaft 180) that runs through a generator/motor (e.g., the generator/motor 121 of FIG. 1A and/or the generator motor 185 of FIG. 1B) to provide mechanical power to a propulsion mechanism like a propeller on an aircraft. In such a mode, the field may be removed from the generator/motor (e.g., the generator/motor may be controlled to be off or disengaged) such that a power shaft and rotor of the generator/motor is spinning or freewheeling and an electrical power I/O (e.g., the electrical power I/O 125 of FIG. 1A) of the generator/motor is therefore disengaged and not outputting electrical power. In short, in the second mode, the engine may drive a power shaft to mechanically or otherwise power a propulsion mechanism, while the power shaft spins within the generator/motor without receiving or outputting electrical power at the electrical power I/O. As described herein, a controller may also be used to control how much power is generated and output by a generator/motor at its electrical power I/O, while allowing the rest of the power on the power shaft to be output to a propulsion device as mechanical power. A propulsion device may be, for example, any of rotor, propeller, fan, or other means of providing propulsion. As such, for example, if batteries on an aircraft are at full charge and electric motors on the aircraft are not be used, it may be desirable to only output mechanical power to a propulsion device and not convert any of the power on the power shaft to electric power. In other examples, it may be desirable to convert just a portion of the mechanical power from the power shaft into electric power. For example, the controller may cause the motor/generator to convert a certain percentage of power into electric power from the power shaft, or may monitor the power shaft to ensure that a minimum threshold of mechanical power is output to a propulsion mechanism (e.g., to maintain a certain airspeed or propulsion mechanism RPM) and then convert the rest of the power from the power shaft into electric power (e.g., to charge batteries or other energy storage devices on board the aircraft). As such, the various embodiments described herein may help prevent batteries on board the aircraft from being overcharged, may reduce the overall fuel consumed, etc., since the generator/motor may be controlled to output a certain amount of electrical power or no/little electrical power even while the power shaft and the rotor of the motor/generator is spinning. In various embodiments, this may be controlled by a controller by using the generator to control how much electrical energy is output, or may also be controlled by disengaging or partially disengaging the power shaft from the rotor of the motor/generator (or vice versa by disengaging the rotor from the power shaft).

In a third mode, which may be referred to herein as an augmented thrust mode, a clutch (e.g., the clutch 115 of FIG. 1 and/or the clutch 175 of FIG. 1B) may engage an engine (e.g., the engine 105 of FIG. 1A and/or the engine 155 of FIG. 1B) to a power shaft (e.g., the power shaft 111 of FIG. 1A and/or the clutch output/power shaft 180) that runs through a generator/motor (e.g., the generator/motor 121 of FIG. 1A and/or the generator motor 185 of FIG. 1B) and the generator/motor is used as a motor to pull power in through an electrical power I/O (e.g., the electrical power I/O 125 of FIG. 1A) from an external source such as a battery pack. This provides a higher mechanical power output on the power shaft than either the engine or the generator/motor may be capable of delivering. In short, in the third mode, both the engine and the generator/motor are used to drive the power shaft simultaneously to send power to a propulsion mechanism.

In a fourth mode, which may be referred to herein as a direct drive generator/motor mode, a clutch (e.g., the clutch 115 of FIG. 1 and/or the clutch 175 of FIG. 1B) may disengage an engine (e.g., the engine 105 of FIG. 1A and/or the engine 155 of FIG. 1B) from a generator/motor (e.g., the generator/motor 121 of FIG. 1A and/or the generator motor 185 of FIG. 1B) such that power can be fed to the generator/motor via an electrical power I/O (e.g., the electrical power I/O 125 of FIG. 1A) to drive the generator/motor as a motor and provide mechanical power to a power shaft (e.g., the power shaft 111 of FIG. 1A and/or the clutch output/power shaft 180). In short, in the fourth mode, the generator/motor alone may provide power to a propulsion mechanism based electrical power received at the electrical power I/O.

In a fifth mode, which may be referred to herein as a split engine power mode, a clutch (e.g., the clutch 115 of FIG. 1 and/or the clutch 175 of FIG. 1B) may engage an engine (e.g., the engine 105 of FIG. 1A and/or the engine 155 of FIG. 1B) to a generator/motor (e.g., the generator/motor 121 of FIG. 1A and/or the generator motor 185 of FIG. 1B) such that the engine may cause the generator/motor to spin as a generator and provide both electrical power to other systems on the aircraft via an electrical power I/O (e.g., the electrical power I/O 125 of FIG. 1A) as well as providing mechanical power to a power shaft (e.g., the power shaft 111 of FIG. 1A and/or the clutch output/power shaft 180) to drive systems like a propeller. In short, in the fifth mode, the engine may be used to drive the power shaft and the generator/motor to output power via the electrical power I/O and the power shaft.

As described herein, any of these five modes (or variations thereof) may be used with the single flexible architecture described herein. In addition, certain modes and or combinations of modes may be beneficial for certain aircraft or aerospace vehicle types, certain propulsion mechanism types, certain flight phases of an aircraft or aerospace vehicle, etc.

For example, in a hybrid electric vertical takeoff and landing (VTOL) aircraft with electric motor driven propellers, the flexible architecture herein may be used solely as a source of electrical power. As such, the flexible architecture may drive the aircraft in the first mode (e.g., the hybrid generator mode) during any portion of a phase of flight in which power must be provided to a power bus of the aircraft or one or more motors of the aircraft.

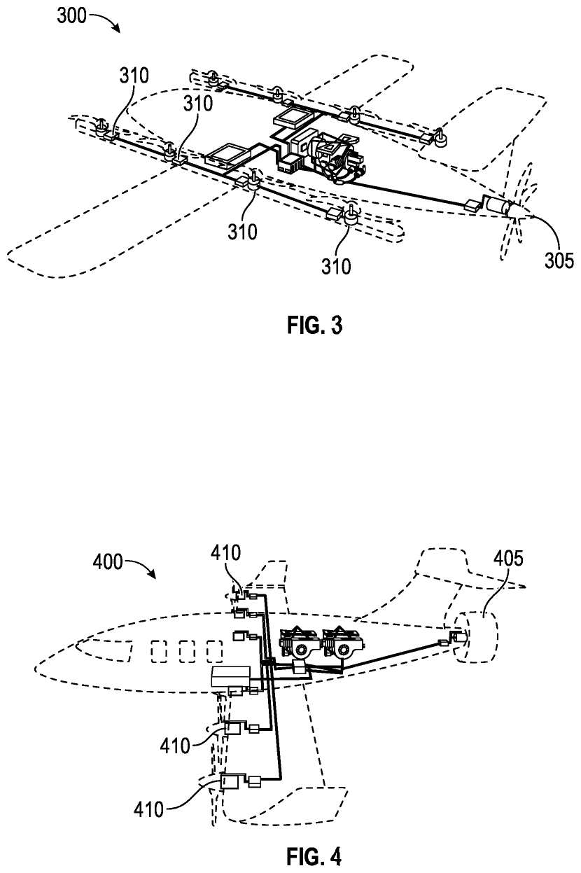

In another example, in an aircraft with a single, large main pusher propeller (e.g., at the rear of a fuselage of an aircraft) and array of electric motors/propellers (e.g., on a wing of an aircraft) the flexible architecture may be used in the fifth mode (e.g., split engine power mode) during takeoff to supply power mechanically to the main pusher propeller and electrically to the wing-mounted motors. FIGS. 3 and 4 illustrate two examples of such an aircraft 300 and 400 with which a flexible architecture for an aerospace hybrid system may be used in accordance with an illustrative embodiment. For example, the aircraft 300 has a main pusher propeller 305, and the aircraft 400 has a main pusher propeller 405 in the form of a ducted pusher fan. In both examples the fifth mode described herein may be used to supply power mechanically to the main pusher propellers 305 and 405 from a power shaft. Additionally, wing mounted electric motors/propellers 310 and 410 may be driven with electrical power from a motor/generator as described herein.

Alternatively, the flexible architecture described herein may be used to power configurations like those shown in FIGS. 3 and 4 in the third mode (e.g., augmented thrust mode) on takeoff by having a battery pack supply power to both the wing-mounted motors and to augment the engine power on the power shaft driving the main pusher propeller. In cruising flight, the aircraft may use the second mode (e.g., the direct drive engine mode) to just drive the main pusher propeller. In another example, during cruising flight, the aircraft may be equipped with a clutch between the power shaft and the pusher propeller, and the controller may cause the aircraft to operate in the first mode (e.g., hybrid generator mode) driving the wing mounted motors by disengaging the power shaft from the pusher propeller and outputting power from the generator/motor to the wing mounted motors. In another example (e.g., an emergency situation such where the engine failure), the pusher prop may be driven in the fourth mode (e.g., the direct drive generator/motor mode) using power input to the electrical power I/O such as from one or more batteries.

In another example, an aircraft may be a VTOL aircraft with a gyrocopter style main rotor that may be operated powered or unpowered, and may have forward propulsion motors and propellers mounted on wings. In an embodiment, the flexible architecture may be used entirely in the first mode (e.g., the hybrid generator mode) with electrical power supplied from the electrical power input/output (and the generator/motor) driving a motor coupled to the gyrocopter style main rotor and driving the wing-mounted motors using electrical power. In an embodiment, the aircraft may also be configured with a clutch between the power shaft and the gyrocopter style main rotor such that the flexible architecture may use the second mode (e.g., the direct drive engine mode) or the third mode (e.g., augmented thrust mode) to spin the gyrocopter style main rotor (e.g., to get the gyrocopter style rotor up to speed for takeoff). In such an example, the controller may then cause the flexible architecture to switch to the first mode (e.g., the hybrid generator mode) after the gyrocopter style rotor is up to speed (e.g., switch to the first mode for cruising flight). The fourth mode (e.g., the direct drive generator/motor mode) may again be used in the event of an engine failure to use electrical power to drive the power shaft (and therefore the gyrocopter style rotor) from a power source such as one or more batteries.

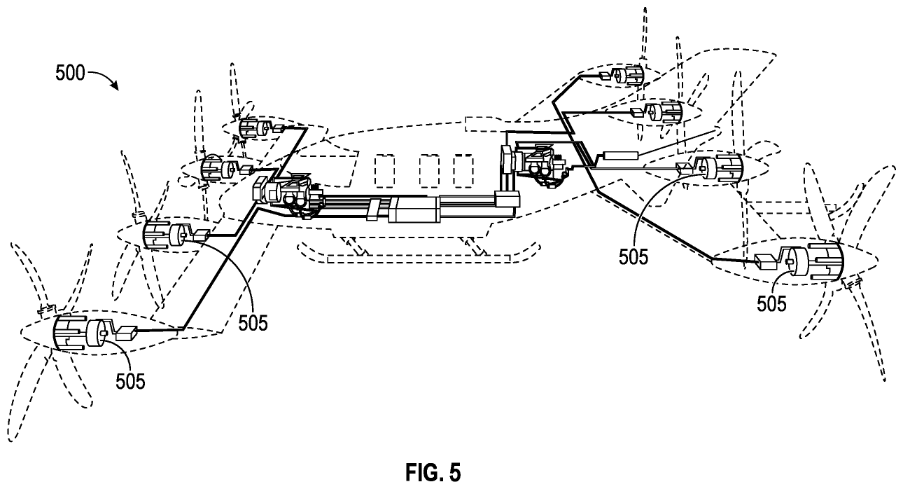

FIG. 5 illustrates another example aircraft 500 with which a flexible architecture for an aerospace hybrid system may be used in accordance with an illustrative embodiment. For example, the aircraft 500 may include multiple (e.g., 8) electric motors/propellers 505 on tilt wings, which may be powered using the first mode described herein (e.g., the hybrid generator mode), where an engine may be engaged with a power shaft using a clutch to drive a generator/motor and output electrical power from the generator/motor to the various electric motors/propellers 505 on the tilt wings.

Accordingly, described herein are advantageous flexible architectures for aircraft through which a variety of modes for supplying power to propulsion mechanisms may be achieved. While particular aircraft and propulsion mechanism configurations may not utilize each mode described herein that a flexible architecture is capable of, the flexible architectures may still be implemented in different aircraft to achieve different modes. Similarly, while an example of a flexible architecture with five different modes for powering propulsion mechanisms is described in detail herein, other flexible architectures with fewer, more, or different modes for powering propulsion mechanisms are also contemplated herein.

For example, a flexible architecture may not have a clutch as described herein and may still be able to implement various modes described herein where it is desirably to have the engine output coupled to the motor/generator and/or an output power shaft of the system. For example, in the first mode, the engine may rotate a power shaft to cause the generator to generate electricity. In the second mode, the engine may direct drive a mechanical propulsion component, for example, but the engine need not be disengaged from the motor/generator or power shaft because the motor/generator can be turned off or allow the power shaft and rotor of the motor/generator to freewheel within the motor/generator. In the third mode, the engine and motor/generator are used to drive the power shaft, so it would not be desirable to disengage the engine and the motor/generator using a clutch. In the fifth mode, the engine may rotate a power shaft to cause the generator to generate electricity and to cause the power shaft to mechanically power a propulsion mechanism. As such, the power shaft need not be disengaged from the engine output in an aircraft that utilizes any of the first, second, third and/or fifth modes as described above. As such, for an implementation that uses any combination of the first, second, third, and/or fifth modes (and not the fourth mode), a clutch may not be used as the system may have the output of the engine constantly connected to the power shaft in the motor/generator. Such an embodiment may be valuable because clutches may be heavy and/or unreliable.

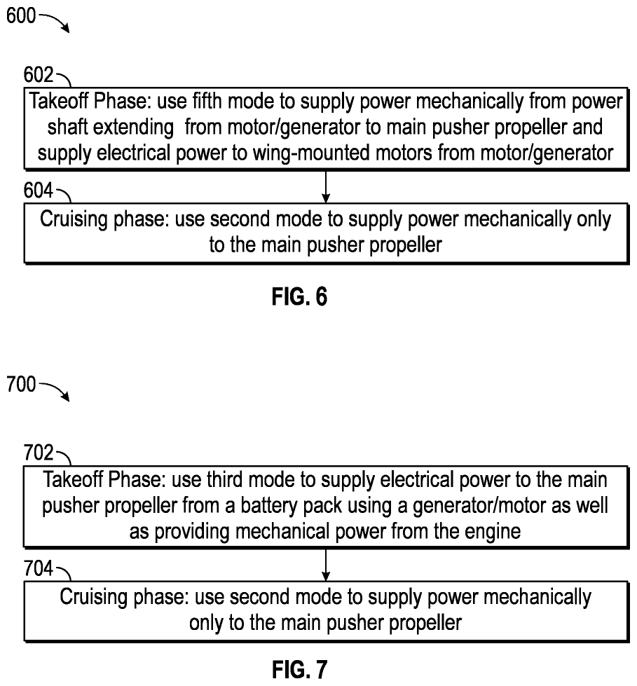

FIG. 6 is a flow chart illustrating a first example method 300 for using a flexible architecture for an aerospace hybrid system in different flight phases of an aircraft with a main pusher propeller in accordance with an illustrative embodiment. In particular, the aircraft may be an aircraft with a single larger pusher propeller and an array of electric motors and corresponding smaller propellers on the wings. During a takeoff flight phase at 602, the fifth mode described herein may be used to supply power mechanically to main pusher propeller and electrical power to wing-mounted motors. During a cruising flight phase at 604, the second mode described herein may be used to supply power mechanically only to the main pusher propeller and not supply power to the smaller electric motors/propellers.

FIG. 7 is a flow chart illustrating a second example method 400 for using a flexible architecture for an aerospace hybrid system in different flight phases of an aircraft with a main pusher propeller in accordance with an illustrative embodiment. In particular, the aircraft may be an aircraft with a single larger pusher propeller and an array of electric motors and corresponding smaller propellers on the wings. During a takeoff flight phase at 702, the third mode described herein called augmented thrust may be used to supply electrical power via a generator/motor to the main pusher propeller (drawing power from batteries) and providing power mechanically directly from the engine to the main pusher propeller. In addition, electrical power (generated by the generator/motor and/or directly from the batteries) may also be provided to the electric motors on the wings during takeoff. During a cruising flight phase at 704, the second mode described herein may be used to supply power mechanically only to the main pusher propeller and not supply power to the smaller electric motors/propellers.

Referring back to FIG. 1A, if the clutch 115 is engaged such that the engine 105 applies power to the power shaft 111 and the generator/motor 121 is not active or on, the power shaft 111 may freewheel within the generator/motor 121 (e.g., the second mode described above). Similarly, the power shaft 180 of FIG. 1B may freewheel within the generator/motor 185 in various embodiments. However, the engine 105 and/or the engine 155 may create torque pulses on the power shaft 111 and/or the power shaft 180 that can be dangerous to a generator, such as the generator/motor 121 and/or the generator/motor 185 when the clutch 115 and/or the clutch 175 is engaged with their respective power shafts 111 and/or 180. In other words, large torque pulses on a shaft similar to those that may occur when certain types of engines fire (e.g., diesel piston combustion engines) may cause high angular accelerations that may cause fatigue or damage to components of the generator/motor 121 and/or the generator/motor 185 that are coupled to the power shafts 111 and/or 180. As such, components to mitigate this torque may be used such as a flywheel or other heavy damping or spring coupling system to smooth out torque on the power shafts 111 and/or 180.

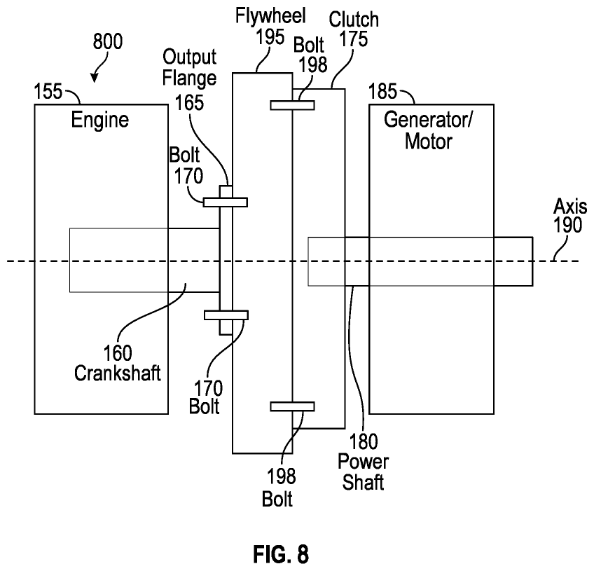

FIG. 8 illustrates an example flexible architecture 800 for an aerospace hybrid system having a flywheel for absorbing oscillatory torque in accordance with an illustrative embodiment. In particular, the flexible architecture 800 includes similar or the same components to that shown in and described with respect to FIG. 1B, but includes a flywheel 195 rigidly connected to the output flange 165 with the bolts 170. The flywheel 195 is further connected rigidly to one side of the clutch 175 by bolts 198. Rotational motion may therefore be translated from the engine 155 through the crankshaft 160, the output flange 165, and the flywheel 195 to the clutch 175. The clutch 175, may in turn engage or disengage with the power shaft 180 to selectively translate the rotational motion received from the flywheel 195 to the power shaft 180. The flywheel 195 may further be, for example, a dual mass flywheel or spring coupling.

In other various embodiments, a flywheel may not be used. For example, further embodiments of damping systems and apparatuses are described herein that can damp torque on a power shaft (e.g., the power shaft 111) but do not include a flywheel. Further, in various embodiments, a flywheel and other damping systems or components may be used in combination to damp or smooth out torque applied to a power shaft.

For example, the power shaft or rotor within the generator/motor itself may be rigidly coupled to a crankshaft of the generator/motor. In this way, the crankshaft and rotor together can damp the torque pulses on the power shaft or rotor, and may reduce tangential acceleration due to the torque pulses from an engine. In such embodiments, a clutch may be omitted. As such, a damping system would be internal to the generator/motor, and the footprint and weight of the damping systems may be less than a flywheel or other damping system that may be external to a generator/motor. In particular, the rigid coupling of the power shaft or rotor with the crankshaft may increase the inertia of the power shaft or rotor, such that the additional inertia helps prevent the power shaft from slowing down or otherwise rotating in a manner that would make it more susceptible to acceleration from torque pulses of an engine. In such embodiments, the power shaft or rotor and the crankshaft may function similarly to a flywheel.

In various embodiments, a generator/motor having a static inner portion and a spinning outer portion may be used. This may increase an inertia of the spinning portion and may allow the magnets in the generator/motor to spin and avoid being dislodged by torque spikes. In other words, the magnets may be already spinning in the outer portion and therefore may have a constant stabilizing radial force applied in addition to any tangential inertial force due to torque spike acceleration.

A torque damping system may also be configured as part of the power shaft or rotor that connects the output of the engine to the generator/motor. For example, a hub between the power shaft or rotor of the generator/motor may include a coupling that has torsional spring and/or damping properties. Torsional damping couplings may include an elastomeric component or spring (e.g., made from steel or another metal) that reduces potentially harmful torque impulses from being passed from an engine output to a power shaft or rotor of a generator. Torsional damping couplings may be similar to or may also be referred to as a resonance damping coupling. For example, such torsional damping couplings may reduce an overall system weight and size as opposed to systems that use a flywheel or other large damping system. One or more torsional damping couplings may be installed at any one or more of, within an engine, between an engine and clutch, in the clutch, between the clutch and the generator, and/or within the generator to achieve damping before the power shaft or rotor damages components of the generator itself.

Other ways of damping torque on a power shaft or rotor of a generator may also be used. For example, a magnetic field on a generator may be controlled to pulse it such that it acts upon the power shaft or rotor of the generator to cancel some or all of the torque pulses imparted on the power shaft or rotor by an engine. Such pulses on the field of the generator may be controlled based on a measurement of the torque pulses applied by the engine, and may result in the generator components not being damaged by the diesel engine. For example, the third mode described above where both an engine and a generator/motor apply power to a power shaft, pulses to the power shaft from the generator may both apply power to the power shaft and protect the components of the generator from being damaged. In the other modes described herein, pulses to the power shaft using the generator may be applied whenever the power shaft is being driven in whole in part by the engine. Thus, in order to properly protect the components of the generator in such a method, the pulses applied by the magnetic field of the generator to the power shaft or rotor may be configured to correlate to the torque pulses of the engine to properly counteract those torque pulses.

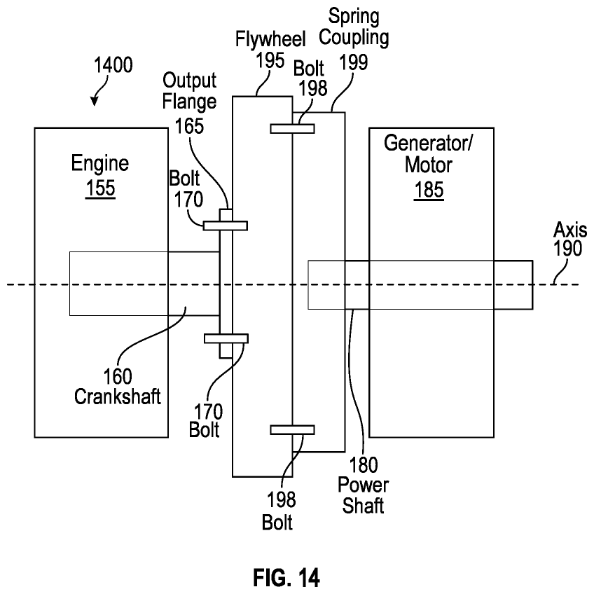

FIG. 14 illustrates an example flexible architecture 1400 for an aerospace hybrid system having a flywheel and a spring coupling for absorbing oscillatory torque in accordance with an illustrative embodiment. In particular, the flexible architecture 1400 includes similar or the same components to that shown in and described with respect to FIG. 8, but includes a spring coupling 199 rigidly connected to the flywheel 195 and the power shaft 180. The size, weight, etc. of the flywheel 195, as well as characteristics of the spring coupling 199, may be tuned according to the output of the engine 155 and the characteristics of one another, so that oscillatory torque may be reduces as much as desired and/or possible. For example, different engines may produce different amounts of oscillatory torque, so the various embodiments herein include flywheels and/or spring couplings having different characteristics to reduce vibration that is passed from the crankshaft 160 to the power shaft 180. In various embodiments, the flexible architecture 1400 may not have a clutch, such that the crankshaft 160 and the power shaft 180 are always coupled to one another. In various embodiments, a flexible architecture similar to that of FIG. 14 may also include a clutch so that the output of the engine 155 can ultimately be releasably decoupled from the power shaft 180. In various embodiments, such a clutch may be connected between the spring coupling 199 and the power shaft 180, or the power shaft may be split into multiple shafts with a clutch connecting the multiple shafts, or the clutch may be located anywhere else between the engine 155 and the generator/motor 185 so that the output of the engine 155 can be selectively decoupled from a portion of the power shaft 180 that passes through the generator/motor 185. In various embodiments, a clutch may additionally or alternatively be positioned after the generator/motor 185 so that the power shaft 180 may be decoupled from a load (e.g., a propulsion mechanism of an aircraft).

Further described below are examples of how the flexible architectures described herein may be packaged and/or used in an actual aircraft. For example, certain aircraft may use electric motors to drive propulsion systems, and therefore must have sufficient on-board electrical energy or ways to generate such on-board electrical energy to drive those propulsion systems. In addition, regulations in a given jurisdiction may also require sufficient reserve energy to comply with operational regulations of an aircraft. The flexible architectures described herein may provide such electrical energy for propulsion systems and/or reserve energy such that they systems described herein may work with a variety of electric aircraft. For example, the embodiments herein provide for efficient conversion of jet fuel (or other liquid or gas fuel) to electricity, such that electric aircraft may be powered using widely available fuel sources.

FIG. 9 illustrates a perspective view 900 of an example flexible architecture for an aerospace hybrid system in accordance with an illustrative embodiment. This hybrid unit may be used as the core powerplant of a variety of aircraft types and implementations. The hybrid unit of FIG. 9 is a tightly integrated powerplant that may include some, all, and/or additional elements shown in and described with respect to FIGS. 1A, 1B, 2A, 2B, and/or FIG. 8.

In addition, the hybrid unit may include an integrated cooling system 905 that cools various aspects of the hybrid unit, heat exchangers related to the hybrid unit, or heat sinks such as finned attachments for any aspects of the hybrid unit. A power output 910 may be a power shaft (e.g., the power shaft 110 of FIG. 1A, the power shaft 180 of FIG. 1B or 8) or connected to a power shaft, so that rotational power may be output from the hybrid unit to propulsion systems or other aspects of an aircraft. Electrical connectors 915 may also be used to output electrical power (or input electrical power) as described herein. The electrical connectors 915 may be, for example, an Amphenol Surlok Plus™ connector or equivalent, or may be any other type of suitable connector. In this way, a main bus, such as a direct current (DC) bus, of the hybrid unit may be connected to through the electrical connectors 915 (e.g., the electrical power input/output 125 of FIG. 1, the electrical I/O power 245 of FIG. 2A or 2B). These or other connectors may also facilitate connection to and control of the components of the hybrid unit, such as using a controller area network (CAN) bus, a CAN 2.0 bus, and/or an SAE J1939 bus. Such communications busses may operate at different speeds, such as 250 kilobytes per second (kbps), 500 kbps, 1000 kbps, etc. In various embodiments, the electrical connectors 915 and/or other connectors may be customized for a given application, such as different types of aircraft and the communications and power systems that those aircraft use.

By virtue of the power output 910 and the electrical connectors 915, the hybrid unit of FIG. 9 may output either mechanical power via the power output 910 and/or electric power via the electrical connectors 915 and the DC bus in the hybrid unit (e.g., the electrical power input/output 125 of FIG. 1, the electrical I/O power 245 of FIG. 2A or 2B). Similarly, electrical power may be received via the electrical connectors 915 to drive the power output 910, just as mechanical power may be received via the power output 910 to generate electricity for output via the electrical connectors 915. For example, if an aircraft includes one or more batteries, extra power from a battery may be received via the electrical connectors 915 to boost power applied to the power output 910, such that the power output 910 is driven by both an engine and power from the batteries of an aircraft as described herein.

The hybrid unit of FIG. 9 may further include connectors 925 for connecting the engine to a fuel source. The connectors 925 may be quick fuel connects, such as AN6 quick fuel connects. In this way, the engine may be supplied with fuel to power the power output 910 and/or to generate electricity to be output via the electrical connectors 915. The hybrid unit of FIG. 9 may additionally include mounting hardware 920 for mounting the hybrid unit to an aircraft. While the mounting hardware 920 is shown on the top of the hybrid unit in FIG. 9, mounting hardware in other embodiments may additionally or alternatively be located on any of the top, bottom, sides, etc. of the hybrid unit, so that the hybrid unit may be mounted as desired to an aircraft.

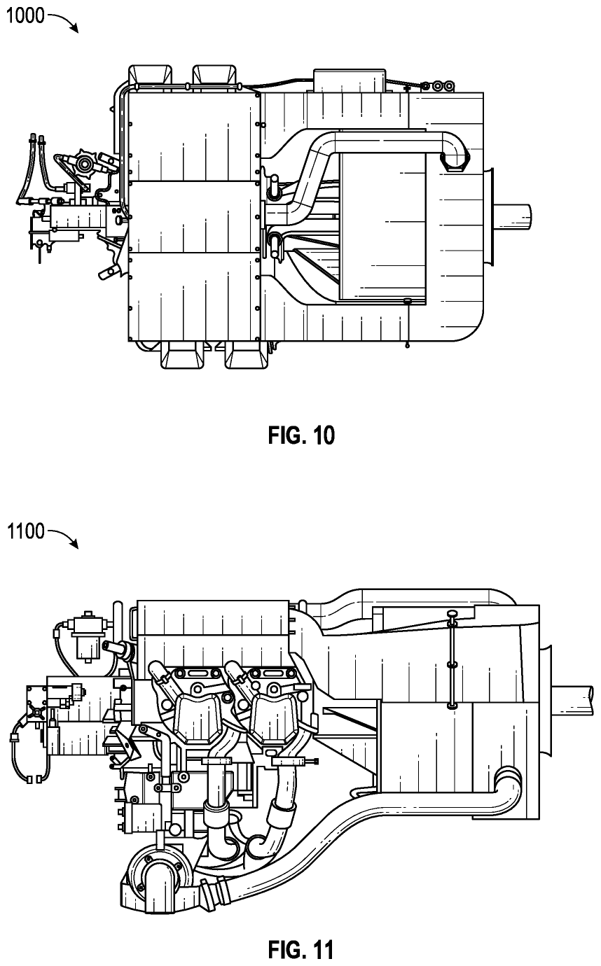

FIG. 10 illustrates a top view 1000 of the example flexible architecture of FIG. 9 in accordance with an illustrative embodiment. FIG. 11 illustrates a side view 1100 of the example flexible architecture of FIG. 9 in accordance with an illustrative embodiment.

Accordingly, the hybrid units described herein may be used to power an electric or hybrid electric aircraft, and may offer better power than a battery pack alone would. For example, a hybrid unit as shown in FIGS. 9-11 may offer better energy density than batteries (e.g., 5 to 7 times better energy density). For example, the hybrid units described herein may have anywhere from 600-1200 or more Watt-hours per kilogram (Wh/kg) equivalent energy density. The hybrid units described herein may also advantageously have better fuel economy than other systems (e.g., 40% better fuel economy than a turbine engine), and may use readily available fuel such as Jet-A, diesel, kerosene, biofuel substitutes, or any other suitable or desired fuel. In other words, the hybrid units herein may include, in a compact package, an engine, a generator, an inverter, and thermal management using air cooling, such that aircraft in which the flexible architecture is installed may advantageously utilize these components as a powerplant. Outputs at various voltages, (e.g., 400 Volts (V), 800V, 1000V, 1200V, etc.) may be supplied from the hybrid architecture, as well as having connections for other accessory or system power (e.g., 28V). The flexible architectures described herein may also be quieter than other systems (e.g., quieter than turbine engine systems). For example, noise may be below 70 decibels (dB) at one hundred feet or less from the current systems.

The flexible architectures described herein may also be scalable. For example, in a larger aircraft, two or more of the flexible architectures described herein may be used. The flexible architectures may also be used in different aircrafts designed for different functions and purposes. For example, the flexible architectures described herein may be useful in urban air mobility (UAM) systems, such as electric vertical takeoff and landing (eVTOL) aircraft, electric short takeoff and landing (eSTOL) aircraft, electric conventional takeoff and landing (eCTOL) aircraft, etc. One example flexible architecture, such as the one shown in FIGS. 9-11, may have the specifications shown in Table 1 below.

TABLE 1
SPECIFICATIONS

| | SI Units | | SAE Units | |
|---|---|---|---|---|
| Max Continuous E-Power | 185 | kW | 248 | hp |
| Max Continuous Shaft Power | 185 | kW | 248 | hp |
| Max Burst Shaft Power* | 370 | kW | 496 | hp |
| Nominal system bus voltage | 400 or 800 V | | 400 or 800 V | |
| Specific Fuel Consumption | 250 | g/kWh | 0.41 | lb/hp-h |
| Ambient temperature range | −40 to 50 C. | | −40 to 122 F. | |
| Ceiling for full takeoff power | 3050 | m | 10,000 | ft |
| Certified ceiling | 6100 | m | 20,000 | ft |
| Dimensions (L × W × H) | 140 × 93 × 84 cm | | 55 × 37 × 33 in | |
| Mass, dry** | 295 | kg | 650 | lb |

*Max burst shaft power depends upon battery configuration
**Dry mass includes engine, generator, inverter, and thermal systems

As shown above, a 185 kW hybrid unit may be provided. Accordingly, two hybrid units may be provided in a given aircraft to provide 370 kW of power.

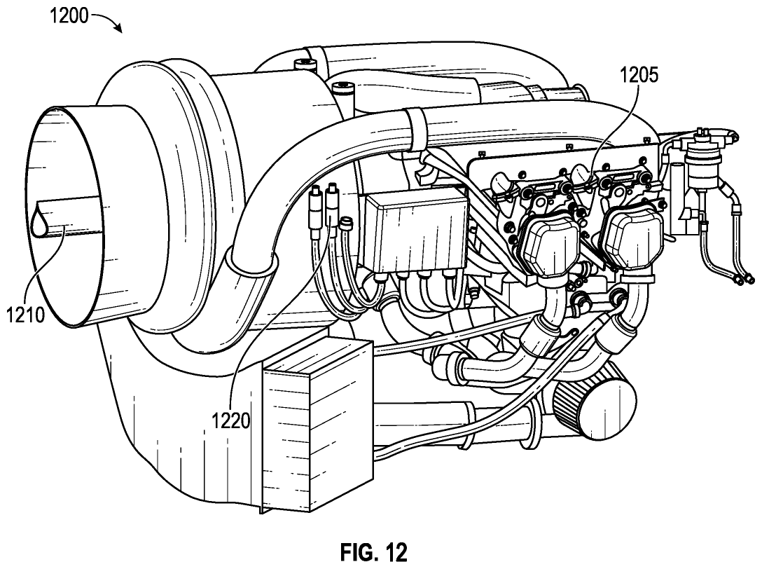

FIG. 12 illustrates a perspective view 1200 of another example flexible architecture for an aerospace hybrid system in accordance with an illustrative embodiment. The flexible architecture of FIG. 12 includes an engine 1205 and a generator, which is hidden or not visible because of other components such as the cooling ducts of the system. However, like the hybrid unit of FIGS. 9-11, a mechanical output power 1210 and electrical output power 1220 (which are also both optionally capable of receiving power as well) are provided.

As such, the various embodiments herein provide for a hybrid electric powerplants that may be incorporated into various different types of aircraft in the aerospace market. In doing so, aircraft manufacturers may not have to build their own systems that are made up of an engine, a generator, power electronics, cooling systems, and/or control systems to provide power to those aircraft. This may be advantageous, as a development process to create a powerplant system and certify it to aerospace standards may last 4+ years and may cost more than $10M.

As such, the hybrid powerplants or flexible architectures described herein may be design, manufactured, etc. separably from the design of the aircraft. A few aspects of the flexible architectures may be customized as desired by an aircraft manufacturer, but in a way that does not cause the total system to be redesigned or reconfigured. The embodiments herein therefore provide for an integrated unit that includes the engine, generator, power electronics, cooling systems, and/or control systems in one package to be installed on an aircraft. Combining these elements into a single standalone unit further advantageously allows for that unit to go through the Federal Aviation Administration (FAA) certification process as a system. Then, multiple aircraft manufacturers may use the certified system, removing that certification burden and development burden from the aircraft developer as well as adding efficiencies where multiple aircraft manufacturers will not have to seek certification of many different powerplant systems specifically designed for their aircraft.

By providing a combined unit having an engine, generator, power electronics, cooling systems, and/or control systems, the hybrid flexible architectures described herein may be optimized as a whole system rather than as individual components. entire system rather than optimization of the pieces. Additionally, such a hybrid unit may be used in multiple aircraft designs, whereas systems designed as part of an aircraft design process are configured such that it is difficult to reapply them elsewhere. Having a hybrid unit that may be applied in multiple market segments and aircraft designs with common power requirements leads to faster development of aircraft where a major component (e.g., the hybrid units or flexible architectures) of an aircraft is already certified and in production.

Hybrid electric systems for aviation have historically been designed from scratch for each application/aircraft. Such a process is inefficient and addressed by the embodiments herein. For example, some aircraft have unique powerplants designed specifically for the aircraft. Such a solution may include custom engine, generator, power electronics, control systems, cooling systems, battery pack, propulsion motors, and/or propellers. The embodiment herein provide for a compact hybrid system for an aircraft that may make up one half of two distinct halves within an aircraft power and propulsion system: upstream and downstream ends of a powertrain (such as a hybrid powertrain as described herein).

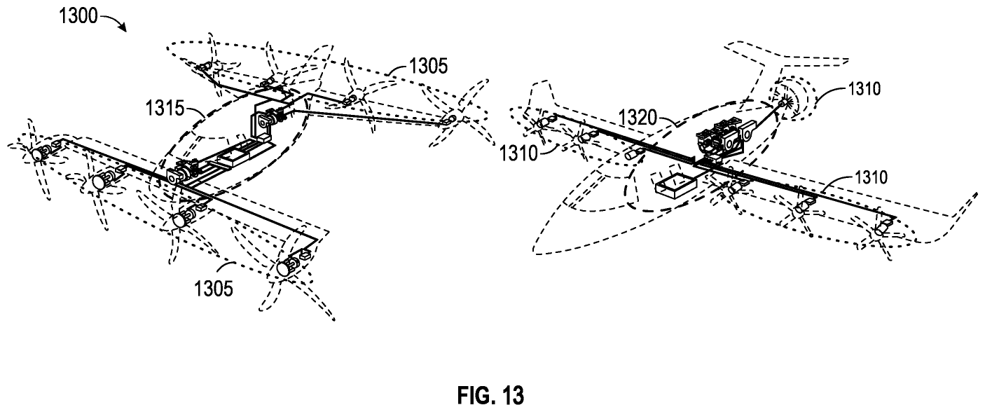

FIG. 13 illustrates example downstream 1305, 1310 and upstream 1315, 1320 components for propelling an aircraft 1300 in accordance with an illustrative embodiment. For example, downstream components 1305, 1310 of an aircraft system may include motors, rotors/propellers, attitude control components, etc., that are more related to the specific design of an aircraft. Upstream components 1315, 1320 of an aircraft that may be repeatable within different aircraft may include any of engines, generators, batteries, power distribution, fuel, generator noise abatement, etc.

Specifically, the upstream end of the powertrain may include hybrid powertrain elements responsible for producing electrical power. Such components may include the engine, generator, power electronics, control systems (for the upstream power generation components), cooling systems (for the upstream components), battery pack, and/or fuel. The downstream end of the powertrain may include hybrid powertrain elements responsible for turning the electrical power into thrust, attitude control, and/or active control of aerodynamics. These downstream components may further include electric motors, propellers, motor controllers, and/or control systems for the propulsion system.

As such, there may be common upstream powertrain needs across very different electric aircraft designs that are of similar sizes and total power requirements. However, the downstream powertrains may have little consistency from one aircraft to the next and therefore these components may not be standardized to work on many aircraft designs the way the upstream components can. Furthermore, the upstream elements that lend themselves to standardization may include the components that are linked to the power requirements but not the total energy requirements. In the case of the engine, generator, power electronics, cooling systems, and/or control systems, these elements of the upstream powertrain may be sized to fit a specific power requirement (kW or hp) of an aircraft. However, the quantity of fuel and the size of the battery pack may be driven by total energy requirements (kWh or hp hr) and these may vary from aircraft to aircraft. In such embodiments, the volume of fuel may be scaled by changing the size of the fuel tank to match the requirements of the aircraft design, and the capacity of the battery pack in kWh may be scaled by adjusting the number of parallel stacks of cells within a battery pack or by adding additional battery packs.

Therefore, provided herein are embodiments for supplying a hybrid powerplant that tightly integrates the engine, generator, power electronics, control systems (for the power generation system), and/or cooling systems in a weight-efficient and space efficient manner that can be certified as a standalone unit designed to provide propulsive power that is separable from the aircraft.

In addition, as described herein, a rotor inside the generator may be optimized to serve multiple purposes in the context of a hybrid powerplant. Conventional combustion engines may have a flywheel mass attached to the rotational shaft to enhance smoothness of operation. However, in the context of an aerospace system it may be unattractive to add extra mass. When an engine is coupled to a generator in a hybrid powerplant as described herein, the rotor in the generator may be designed to withstand any torque impulses from the engine and it may be designed to be the rotating mass that the engine utilizes for smoothness of operation.

Further, while auxiliary power units are known in the prior art, these systems may be designed for different purposes than as a primary source of propulsion power for an aircraft, and therefore may not have control systems capable of being certified to the standards required for use in propulsion. Additionally, such systems may be designed without the cooling systems, leaving that aspect to the airframe designer. As such, these systems are not certified to Part 33 (FAA regulations for aircraft powerplants). Also, these auxiliary power unit systems are designed to be lightweight auxiliary systems that are used intermittently rather than for highly efficient propulsion systems that are used in all phases of flight. Additionally, auxiliary power units may be designed to produce alternating current (AC) power, whereas hybrid electric powerplants as described herein may produce direct current (DC) power so that the hybrid electric powerplants may be coupled to a large propulsive battery pack, as battery packs provide and are charged using DC power.

Turbogenerators are a type of adapted auxiliary power units that have been proposed for hybrid power. Such systems lack cooling system integration that provides an airframe developer with a cooling system that is part of the hybrid powerplant. As such, airframe developers may be left to design their own cooling systems to accompany use of a turbogenerator. Using the embodiments herein, separate cooling systems for cooling the hybrid powerplants described herein may advantageously not need to be designed or developed for particular airframes, as such cooling systems are already included in the flexible architectures described herein.

As such, the flexible architectures and hybrid electric powerplants described herein advantageously provide an engine that converts liquid fuel (or gaseous fuel) into rotational mechanical power, a generator coupled to the engine that is configured to convert the rotational mechanical power to electricity, and/or power electronics coupled to the generator that are configured to convert the direct AC output of the generator to high voltage DC power. The flexible architectures and hybrid electric powerplants described herein further advantageously provide control systems that are configured to vary the power output of the engine to match the power demand on a main propulsive electrical bus of an aircraft to meet the demands of an aircraft for electric power.

Hybrid powerplant control systems, power electronics, generator, and/or engine designs described herein may further comply with regulatory requirements for the reliability of propulsive aerospace systems (e.g., failure should have a probability of less than 10⁻⁶ or ten to the power of negative six). Flexible architectures and hybrid electric powerplants may further include a control interface that enables the flexible architecture or hybrid powerplant to communicate with a vehicle-level flight control systems to enable propulsive power commands to be provided from the vehicle-level flight control systems to the hybrid-powerplant control systems, and also advantageously provide for the hybrid-powerplant control systems to send status messages back to the vehicle-level flight control systems (e.g., feedback for use in controlling the flexible architecture or hybrid powerplant). Flexible architectures and hybrid electric powerplants may further include cooling systems that maintain the temperature range of the generator, power electronics, and/or engine over a full range of operating power output of the flexible architectures and hybrid electric powerplants described herein.

Various embodiments of flexible architectures or hybrid electric powerplants described herein may further include control systems that vary power output by varying engine torque and/or maintain rotations per minute (RPM) substantially constant over a significant range of power output. Such embodiments may provide for faster response of the flexible architectures or hybrid electric powerplants by eliminating throttle lag and a longer response time relating to system rotational inertia.

Various embodiments of flexible architectures or hybrid electric powerplants described herein may further include the option to provide a portion of the engine's power output as mechanical shaft power and a portion provided as DC electrical power. Various embodiments of flexible architectures or hybrid electric powerplants described herein may further include that the engine may be a piston engine, diesel piston engine, turbine engine, rotary engine, or other forms of combustion engine. Various embodiments of flexible architectures or hybrid electric powerplants described herein may further include examples where the rotor of the generator is designed to be a flywheel for the engine. Various embodiments of flexible architectures or hybrid electric powerplants described herein may further include a clutch between the engine and generator to enable operation of the generator as a motor that can be operated while the engine is shut down in some types of parallel hybrid installations as described herein.

At least some aspects of the present disclosure will now be described with reference to the following numbered clauses:
1. A hybrid powertrain system comprising:
an engine; and
an electric machine having a power shaft therein, wherein the electric machine further comprises an electrical input/output, wherein:
the power shaft is configured to mechanically attach to and provide mechanical power to a propulsion device;
an output of the engine is configured to rotate the power shaft;
the engine and the electric machine are configured to operate in a first mode in which the electric machine is controlled to convert a variable amount of power from the power shaft's rotation by the engine into first electrical power while the power shaft is further configured to output any remaining mechanical power of the power shaft to the propulsion device; and
the engine and the electric machine are configured to operate in a second mode in which both the engine and the electric machine drive the power shaft, wherein the electric machine drives the power shaft based on second electrical power received via the electrical input/output.
2. The hybrid powertrain system of clause 1, wherein the first electrical power is configured to be output to an electric propulsion device of the aircraft.
3. The hybrid powertrain system of clause 2, wherein the electric propulsion device of the aircraft comprises at least one battery and at least one electric motor used for electric propulsion of the aircraft, wherein the at least one battery and the at least one electric motor are mounted to the aircraft.
4. The hybrid powertrain system of clause 1, wherein in the first mode, the electric machine is controlled to convert no power from the power shaft into the first electric power.
5. The hybrid powertrain system of clause 1, wherein in the first mode, the electric machine is controlled to convert all power from the power shaft into the first electric power.
6. The hybrid powertrain system of clause 1, wherein in the first mode, the electric machine is controlled to convert somewhere between 0% and 100% of the power on the power shaft into the first electric power.
7. The hybrid powertrain system of clause 5, further comprising a controller configured to cause the electric machine to vary a percentage of power converted from the power shaft to the first electric power by the electric machine.
8. The hybrid powertrain system of clause 1, further comprising a controller configured to control the engine and the electric machine to output a first desired amount of the mechanical power to the propulsion mechanism and to output a second desired amount of the first electric power from the electric machine.
9. The hybrid powertrain system of clause 1, further comprising a flywheel connected to at least one of the power shaft or the output of the engine.
10. The hybrid powertrain system of clause 9, further comprising a spring coupling connected to the flywheel, wherein the spring coupling is configured to reduce vibration transmitted from the flywheel to the power shaft.
11. The hybrid powertrain system of clause 1, wherein the second electrical power is received from one or more batteries of the aircraft during the second mode.
12. The hybrid powertrain system of claim 1, wherein the first electrical power is output to at least one of an electric motor or a battery.
13. The hybrid powertrain system of clause 1, at least one of the power shaft or the output of the engine further supplies rotational power to a cooling system of the hybrid powertrain system.
14. A method comprising:
controlling an engine and an electric machine having a power shaft therein to operate in a first mode comprising:
driving the power shaft by the engine, wherein an output of the engine is configured to rotate the power shaft; and
outputting first electrical power from the electric machine through an electrical input/output of the electric machine based on the rotating of the power shaft by the engine; and
controlling the engine and the electric machine to operate in a second mode comprising driving the power shaft by the engine and the electric machine simultaneously, wherein the electric machine drives the power shaft based on second electrical power received via the electrical input/output.
15. The method of clause 14, wherein the first electrical power is output to drive an electric propulsion motor of the aircraft or output to a propulsion battery of the aircraft, wherein the propulsion battery is used to power the electric propulsion motor.
16. The method of clause 14, wherein the power shaft is configured to mechanically attach to and provide mechanical power to a propulsion device.
17. The method of clause 14, wherein a flywheel is connected to at least one of the power shaft or the output of the engine.
18. The method of clause 17, wherein a spring coupling is connected to the flywheel, and wherein the spring coupling is configured to reduce vibration transmitted from the flywheel to the power shaft.
19. The method of clause 14, wherein during the first mode, a first portion of rotational power applied to the power shaft by the engine is converted to electrical power by the electric machine and a second portion of the rotational power is supplied to the propulsion device via the power shaft.
20. The method of clause 14, further comprising engaging a clutch during both the first mode and the second mode, wherein the clutch is configured to releasably engage the output of the engine to the power shaft.
21. A hybrid powertrain system comprising:
an engine;
an electric machine having a power shaft therein; and
a clutch configured to releasably engage an output of the engine and the power shaft of the electric machine, wherein:
the electric machine further comprises an electrical output;
the power shaft is configured to mechanically attach to and provide mechanical power to a propulsion device; and
a controller configured to control the engine, the electric machine, and the clutch to implement one or more power output modes.
22. The hybrid powertrain system of clause 21, wherein the electric machine further comprises an electrical input, and wherein, in a mode of the one or more power output modes, the electric machine is configured to receive power via the electrical input from an electric energy storage device to drive the power shaft.
23. The hybrid powertrain system of clause 22, wherein, during the mode, the clutch is disengaged such that the output of the engine does not rotate the power shaft.
24. The hybrid powertrain system of clause 22, wherein, during the mode, the clutch is engaged such that the output of the engine rotates the power shaft.
25. The hybrid powertrain system of clause 21, wherein the electric machine further comprises an electrical input, and wherein the one or more power output modes comprise at least:
a first mode in which the electric machine outputs first electrical power through the electrical output based on rotation of the power shaft, wherein the power shaft is rotated by the engine while the clutch is engaged to couple the output of the engine and the power shaft; and
a second mode in which both the engine and the electric machine drive the power shaft, wherein the electric machine drives the power shaft based on second electrical power received via the electrical input and the clutch is engaged to couple the output of the engine and the power shaft.
26. The hybrid powertrain system of clause 21, wherein, in a mode of the one or more power output modes:
the clutch is engaged and the engine rotates the power shaft;
the electric machine is configured to receive power via the power shaft and convert a first portion of rotational power of the power shaft to electrical power that is output via the electrical output; and
a second portion of the rotational power of the power shaft is applied to the propulsion device as the mechanical power.
27. The hybrid powertrain system of clause 21, wherein, in a mode of the one or more power output modes:
the clutch is engaged and the engine rotates the power shaft;
the power shaft is configured to rotate within the electric machine without the electric machine converting rotational power of the power shaft to electrical power; and
the rotational power of the power shaft is applied to the propulsion device as the mechanical power.
28. A hybrid powertrain system comprising:
an engine;
a power shaft;
an electric machine having the power shaft therein, wherein the electric machine further comprises an electrical input/output; and
a clutch configured to releasably engage an output of the engine to the power shaft,
wherein:
the electric machine is configured to receive power via the electrical input/output from an electric energy storage device to drive the power shaft;
the electric machine is configured to output power via the electrical input/output upon rotation of the power shaft by the engine; and
the power shaft is configured to mechanically attach to and provide mechanical power to a propulsion device.
29. The hybrid powertrain system of clause 28, wherein the electric machine is further configured to output the power via the electrical input/output to at least one of an electric motor or the electric energy storage device.
30. The hybrid powertrain system of clause 28, wherein the electric machine cannot receive power to drive the electric machine and output power to at least one of the electric motor or the electric energy storage device at the same time.
31. The hybrid powertrain system of clause 28, wherein the electric machine is controllable such that little or no electrical power is output by the electric machine despite rotation of the power shaft.
32. The hybrid powertrain system of clause 31, wherein while the electric machine is controllable such that little or no electrical power is output by the electric machine, little or no power is input or output by the electric machine at the electrical input/output.
33. The hybrid powertrain system of clause 28, wherein while the electric machine outputs power via the electrical input/output upon the rotation of the power shaft by the engine, the electric machine is configured to convert only a portion of the rotational energy provided by the power shaft into electrical power that is output at the electrical input/output.
34. The hybrid powertrain system of clause 28, wherein the clutch is configured to disengage the output of the engine from the power shaft while the electric machine drives the power shaft with electrical power received via the electrical input/output.
35. The hybrid powertrain system of clause 28, wherein the power shaft is configured to be driven by the electric machine and the engine simultaneously while the clutch is engaged to connect the output of the engine to the power shaft.
36. The hybrid powertrain system of clause 28, wherein the clutch comprises a one-way clutch configured to disengage the output of the engine from the power shaft while the electric machine is rotating the power shaft faster than the output of the engine.
37. The hybrid powertrain system of clause 28, wherein the one-way clutch comprises a sprag clutch.

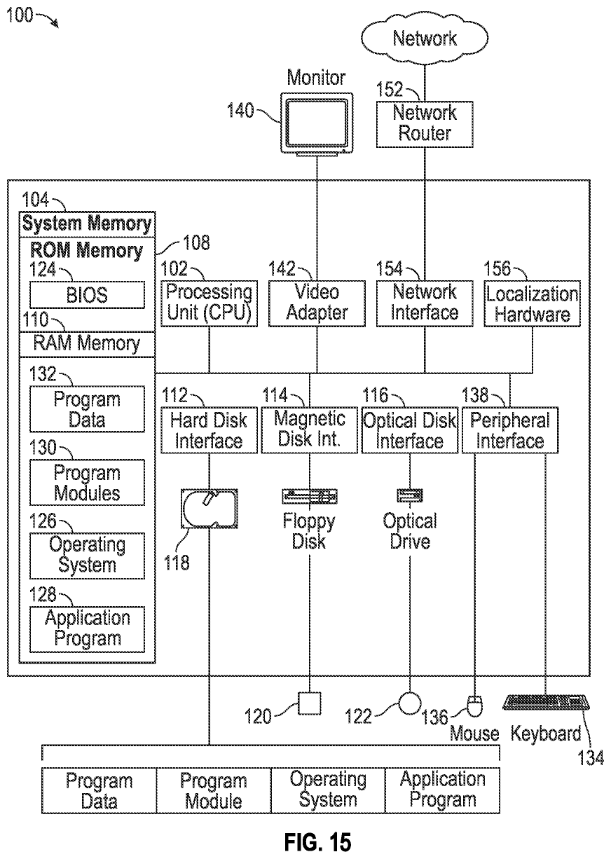

FIG. 15 is a diagrammatic view of an example of a computing environment that includes a general-purpose computing system environment 100, such as a desktop computer, laptop, smartphone, tablet, or any other such device having the ability to execute instructions, such as those stored within a non-transient, computer-readable medium. Various computing devices as disclosed herein (e.g., the processor(s)/controller(s) 205, the main aircraft controller 220, the processor(s)/controller(s) 280, or any other computing device in communication with those controllers that may be part of other components of an aircraft or control system of an aircraft—whether on board the aircraft or remote from the aircraft) may be similar to the computing system 100 or may include some components of the computing system 100. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 306, respectively, allow for reading from and writing to a hard disk 118, reading from or writing to a removable magnetic disk 120, and/or for reading from or writing to a removable optical disk 122, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, and/or peripheral memory devices may be used to store computer executable instructions comprising an operating system 126, one or more applications programs 128 (which may include the functionality disclosed herein, for example), other program modules 130, and/or program data 122. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 132. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In some instances, the localization hardware 156 may include, for example only, a GPS antenna, an RFID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

In an illustrative embodiment, any of the operations described herein may be implemented at least in part as computer-readable instructions stored on a computer-readable medium or memory. Upon execution of the computer-readable instructions by a processor, the computer-readable instructions may cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or from practice of the disclosed embodiments. It is intended that the scope of the invention be defined by the claims appended hereto and their equivalents.

What is claimed is:

1. A hybrid powertrain system comprising:
an engine; and
an electric machine having a power shaft therein, wherein the electric machine further comprises an electrical input/output, wherein:
the power shaft is configured to mechanically attach to and provide mechanical power to a propulsion device;
an output of the engine is configured to rotate the power shaft;
the engine and the electric machine are configured to operate in a first mode in which the electric machine is controlled to convert a variable amount of power from the power shaft's rotation by the engine into first electrical power while the power shaft is further configured to output any remaining mechanical power of the power shaft to the propulsion device; and
the engine and the electric machine are configured to operate in a second mode in which both the engine and the electric machine drive the power shaft, wherein the electric machine drives the power shaft based on second electrical power received via the electrical input/output.

2. The hybrid powertrain system of claim 1, wherein the first electrical power is configured to be output to an electric propulsion device of the aircraft.

3. The hybrid powertrain system of claim 2, wherein the electric propulsion device of the aircraft comprises at least one battery and at least one electric motor used for electric propulsion of the aircraft, wherein the at least one battery and the at least one electric motor are mounted to the aircraft.

4. The hybrid powertrain system of claim 1, wherein in the first mode, the electric machine is controlled to convert no power from the power shaft into the first electric power.

5. The hybrid powertrain system of claim 1, wherein in the first mode, the electric machine is controlled to convert all power from the power shaft into the first electric power.

6. The hybrid powertrain system of claim 1, wherein in the first mode, the electric machine is controlled to convert somewhere between 0% and 100% of the power on the power shaft into the first electric power.

7. The hybrid powertrain system of claim 5, further comprising a controller configured to cause the electric machine to vary a percentage of power converted from the power shaft to the first electric power by the electric machine.

8. The hybrid powertrain system of claim 1, further comprising a controller configured to control the engine and the electric machine to output a first desired amount of the mechanical power to the propulsion mechanism and to output a second desired amount of the first electric power from the electric machine.

9. The hybrid powertrain system of claim 1, further comprising a flywheel connected to at least one of the power shaft or the output of the engine.

10. The hybrid powertrain system of claim 9, further comprising a spring coupling connected to the flywheel, wherein the spring coupling is configured to reduce vibration transmitted from the flywheel to the power shaft.

11. The hybrid powertrain system of claim 1, wherein the second electrical power is received from one or more batteries of the aircraft during the second mode.

12. The hybrid powertrain system of claim 1, wherein the first electrical power is output to at least one of an electric motor or a battery.

13. The hybrid powertrain system of claim 1, at least one of the power shaft or the output of the engine further supplies rotational power to a cooling system of the hybrid powertrain system.

14. A method comprising:
controlling an engine and an electric machine having a power shaft therein to operate in a first mode comprising:
driving the power shaft by the engine, wherein an output of the engine is configured to rotate the power shaft; and
outputting first electrical power from the electric machine through an electrical input/output of the electric machine based on the rotating of the power shaft by the engine; and
controlling the engine and the electric machine to operate in a second mode comprising driving the power shaft by the engine and the electric machine simultaneously, wherein the electric machine drives the power shaft based on second electrical power received via the electrical input/output.

15. The method of claim 14, wherein the first electrical power is output to drive an electric propulsion motor of the aircraft or output to a propulsion battery of the aircraft, wherein the propulsion battery is used to power the electric propulsion motor.

16. The method of claim 14, wherein the power shaft is configured to mechanically attach to and provide mechanical power to a propulsion device.

17. The method of claim 14, wherein a flywheel is connected to at least one of the power shaft or the output of the engine.

18. The method of claim 17, wherein a spring coupling is connected to the flywheel, and wherein the spring coupling is configured to reduce vibration transmitted from the flywheel to the power shaft.

19. The method of claim 14, wherein during the first mode, a first portion of rotational power applied to the power shaft by the engine is converted to electrical power by the electric machine and a second portion of the rotational power is supplied to the propulsion device via the power shaft.

20. The method of claim 14, further comprising engaging a clutch during both the first mode and the second mode, wherein the clutch is configured to releasably engage the output of the engine to the power shaft.

21. A hybrid powertrain system comprising:
an engine;
an electric machine having a power shaft therein; and
a clutch configured to releasably engage an output of the engine to the power shaft of the electric machine, wherein:
the electric machine further comprises an electrical output;
the power shaft is configured to mechanically attach to and provide mechanical power to a propulsion device; and
a controller configured to control the engine, the electric machine, and the clutch to implement one or more power output modes.

22. The hybrid powertrain system of claim 21, wherein the electric machine further comprises an electrical input, and wherein, in a mode of the one or more power output modes, the electric machine is configured to receive power via the electrical input from an electric energy storage device to drive the power shaft.

23. The hybrid powertrain system of claim 22, wherein, during the mode, the clutch is disengaged such that the output of the engine does not rotate the power shaft.

24. The hybrid powertrain system of claim 22, wherein, during the mode, the clutch is engaged such that the output of the engine rotates the power shaft.

25. The hybrid powertrain system of claim 21, wherein the electric machine further comprises an electrical input, and wherein the one or more power output modes comprise at least:
a first mode in which the electric machine outputs first electrical power through the electrical output based on rotation of the power shaft, wherein the power shaft is rotated by the engine while the clutch is engaged to couple the output of the engine and the power shaft; and
a second mode in which both the engine and the electric machine drive the power shaft, wherein the electric machine drives the power shaft based on second electrical power received via the electrical input and the clutch is engaged to couple the output of the engine and the power shaft.

26. The hybrid powertrain system of claim 21, wherein, in a mode of the one or more power output modes:
the clutch is engaged and the engine rotates the power shaft;
the electric machine is configured to receive power via the power shaft and convert a first portion of rotational power of the power shaft to electrical power that is output via the electrical output; and
a second portion of the rotational power of the power shaft is applied to the propulsion device as the mechanical power.

27. The hybrid powertrain system of claim 21, wherein, in a mode of the one or more power output modes:
the clutch is engaged and the engine rotates the power shaft;
the power shaft is configured to rotate within the electric machine without the electric machine converting rotational power of the power shaft to electrical power; and
the rotational power of the power shaft is applied to the propulsion device as the mechanical power.

28. The hybrid powertrain system of claim 21, wherein the electric machine is controllable such that little or no electrical power is output by the electric machine despite rotation of the power shaft.

29. The hybrid powertrain system of claim 21, wherein while the electric machine outputs power via the electrical input/output upon the rotation of the power shaft by the engine, the electric machine is configured to convert only a portion of the rotational energy provided by the power shaft into electrical power that is output at the electrical input/output.

30. The hybrid powertrain system of claim 21, wherein the power shaft is configured to be driven by the electric machine and the engine simultaneously while the clutch is engaged to connect the output of the engine to the power shaft.
